(19) United States
(12) Patent Application Publication
(10) Pub. No.: US 2025/0179850 A1
(43) Pub. Date: Jun. 5, 2025

(54) PANEL ASSEMBLY

(71) Applicant: Kohler (China) Investment Co., Ltd., Shanghai (CN)

(72) Inventor: Bin Guo, Shanghai (CN)

(21) Appl. No.: 18/951,494

(22) Filed: Nov. 18, 2024

(30) Foreign Application Priority Data
Nov. 30, 2023 (CN) 202323268240.3

(51) Int. Cl. E05D 3/12

(52) U.S. Cl. CPC E05D 3/12; E05Y 2201/11; E05Y 2201/48; E05Y 2800/353; E05Y 2900/131; E05Y 2900/302

(57) ABSTRACT

A panel assembly includes a panel mounting frame; a panel cover; and a hinge configured to connect the panel cover to the panel mounting frame. The hinge includes a hinge plate; a first pivot shaft disposed on a first side of the hinge plate and configured to be pivotally connected to the panel mounting frame; and a second pivot shaft disposed on a second side of the hinge plate and configured to be pivotally connected to the panel cover. The panel assembly also includes an elastic element configured to drive the hinge plate to rotate and disposed between the panel mounting frame and the hinge plate. The elastic element is in a compressed state when the panel cover is in a closed state relative to the panel mounting frame.

### CROSS REFERENCE TO RELATED APPLICATION

This application claims the benefit of priority to: Chinese Patent Application No. 202323268240.3 filed in the Chinese Intellectual Property Office on Nov. 30, 2023, which is hereby incorporated by reference in its entirety.

### FIELD

The present disclosure relates to the technical field of panels for a hidden water tank and particularly relates to a panel assembly for a hidden water tank.

### BACKGROUND

Some toilets include a hidden water tank, and the hidden water tank is a water tank of a toilet and is mounted in the wall. Then, a water tank panel is mounted in an opening of the wall, and the water tank panel includes buttons and other operating mechanisms for opening the water valve in the water tank.

The water tank panel comprises a frame structure connected to the wall and a panel structure, and the panel structure is connected to the frame structure by means of a hinge. In order to enable the panel structure to be opened at a larger angle, both ends of the hinge are connected to the frame structure and the panel structure by means of pivot shafts, respectively. When opening the panel structure, a user first pulls the panel structure outward so that the panel structure rotates with the hinge around the pivot shaft connected to the frame structure. Then, the user swings panel structure so that the panel structure rotates around the pivot shaft connecting it to the hinge. Because the panel structure usually contacts the wall, if the user does not pull the panel structure outwards but directly turns over the panel structure, it is easy to cause the panel structure to collide with the wall. This generates noise and also damages the product. The existing panel structure of the water tank requires the user to perform two actions when opening the panel structure. This results in a poor user experience.

### SUMMARY

The present disclosure aims to overcome the above shortcomings and provide a novel panel assembly. An elastic element is disposed between a panel mounting frame and a hinge plate. When a user opens a panel cover, the elastic element drives the hinge plate and a first pivot shaft to rotate, such that the panel cover automatically opens at a certain angle and moves away from the wall. Then, the user only needs to turn over the panel cover to open it completely. This is convenient for operation and enhances the user experience.

The present disclosure provides a panel assembly, including a panel mounting frame, a panel cover, and a hinge configured to connect the panel cover to the panel mounting frame.

The hinge includes a hinge plate, a first pivot shaft, and a second pivot shaft, and the first pivot shaft and the second pivot shaft are disposed on opposite sides of the hinge plate.

The first pivot shaft is pivotally connected to the panel mounting frame and the second pivot shaft is pivotally connected to the panel cover.

An elastic element configured to drive the hinge plate to rotate is disposed between the panel mounting frame and the hinge plate.

The elastic element is in a compressed state when the panel cover is in a closed state relative to the panel mounting frame.

In an embodiment, a frame edge extending plate is disposed on an inner side of one frame edge of the panel mounting frame, and the first pivot shaft is pivotally connected to the frame edge extending plate.

The elastic element is assembled between the hinge plate and the frame edge extending plate.

In an embodiment, the elastic element includes an elastic sheet, one end of the elastic sheet is connected to the hinge plate or the frame edge extending plate, and the other end of the elastic sheet extends toward the frame edge extending plate or the hinge plate.

In an embodiment, the hinge plate includes a hinge plate through hole. One end of the elastic sheet is connected to the hinge. At least a portion of the elastic sheet is disposed in the hinge plate through hole. The other end of the elastic sheet extends out of the hinge plate through hole and extends toward the frame edge extending plate.

In an embodiment, the elastic sheet includes a connecting sheet and an inclined extending sheet connected to the connecting sheet and extending at an angle (e.g., obliquely with respect to the connecting sheet).

The connecting sheet is disposed in the hinge plate through hole and connected to a hole wall of the hinge plate through hole, and the inclined extending sheet extends toward the frame edge extending plate.

When the panel cover is in the closed state relative to the panel mounting frame, the inclined extending sheet is compressed into the hinge plate through hole by the frame edge extending plate.

In an embodiment, the elastic sheet is integrally formed with the hinge plate.

In an embodiment, the hinge plate extends along a height direction of the panel mounting frame.

Two first pivot shafts are disposed on one side of the hinge plate, and the two first pivot shafts are arranged vertically apart from each other and pivotably connected to the panel mounting frame, respectively.

Two second pivot shafts are disposed on the other side of the hinge plate, the two second pivot shafts are arranged vertically apart from each other and pivotably connected to the panel cover, respectively.

In an embodiment, the hinge plate includes a plurality of lightening holes.

In an embodiment, a first buckle is disposed on the side of the panel cover away from the hinge, and an elastic clamping slot is disposed on the side of the panel mounting frame away from the hinge.

When the panel cover is in the closed state relative to the panel mounting frame, the first buckle is fitted into (e.g., disposed in, inserted into, engaged with, etc.) the elastic clamping slot.

In an embodiment, a second buckle is disposed on the side of the panel cover adjacent to the hinge, and a clamping convex is disposed on an inner side of a frame edge of the panel mounting frame adjacent to the hinge.

When the panel cover is in the closed state relative to the panel mounting frame, the second buckle is clamped with (e.g., disposed in, inserted into, engaged with, etc.) the clamping convex.

By adopting the above technical solutions, the present disclosure has the following beneficial effects.

The panel assembly according to the present disclosure includes a panel mounting frame, a panel cover, a hinge, and an elastic element. The hinge comprises a hinge plate, a first pivot shaft, and a second pivot shaft. The first pivot shaft is pivotally connected to the panel mounting frame, and the second pivot shaft is pivotally connected to the panel cover. The elastic element is disposed between the panel mounting frame and the hinge plate. When a user opens the panel cover, the elastic element drives the hinge plate to rotate, such that the panel cover automatically opens at a certain angle and moves away from the wall. Then, the user only needs to turn over the panel cover to open it completely. This is convenient for operation and enhances the user experience.

### BRIEF DESCRIPTION OF THE FIGURES

By reference to the drawings, the contents disclosed by the present disclosure should be more easily understood. It should be understood that these drawings are merely used for illustration and are not intended to limit the protection scope of the present disclosure. In the drawings:

FIG. 1 is a perspective view of a panel assembly according to an embodiment of the present disclosure, with a panel cover and a panel mounting frame being in an opened state;

FIG. 2 is an enlarged schematic view of a hinge connection portion of the panel assembly shown in FIG. 1;

FIG. 3 is a perspective view of a hinge;

FIG. 4 is a front view of the hinge;

FIG. 5 is a sectional diagram of the hinge shown in FIG. 4 along the A-A direction;

FIG. 6 is a rear view of the panel cover;

FIG. 7 is a front view of a panel mounting frame;

FIG. 8 is a sectional view of the panel assembly according to an embodiment of the present disclosure in a closed state, in which the sectional surface passes through an elastic sheet;

FIG. 9 is an enlarged schematic view of part B of FIG. 8;

FIG. 10 is a schematic view of the panel assembly mounted on a wall in a closed state;

FIG. 11 is a perspective view of the panel assembly shown in FIG. 10, with the panel cover being opened; and

FIG. 12 is a flow chart of a method for manufacturing a panel assembly according to an embodiment of the present disclosure.

### DETAILED DESCRIPTION

The embodiments of the present disclosure are further described with reference to the drawings hereinafter. Same or equivalent parts are denoted by the same reference numerals. It should be noted that the terms “front”, “rear”, “left”, “right”, “up” and “down” used in the following descriptions refer to the directions in the drawings, and the terms “inner” and “outer” refer to the directions toward or far away from geometric centers of specific parts respectively.

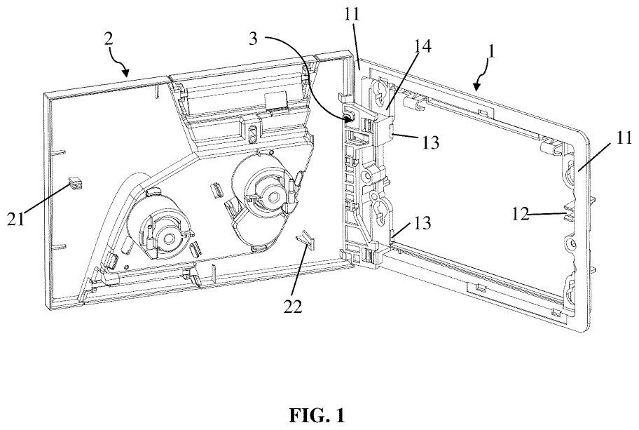

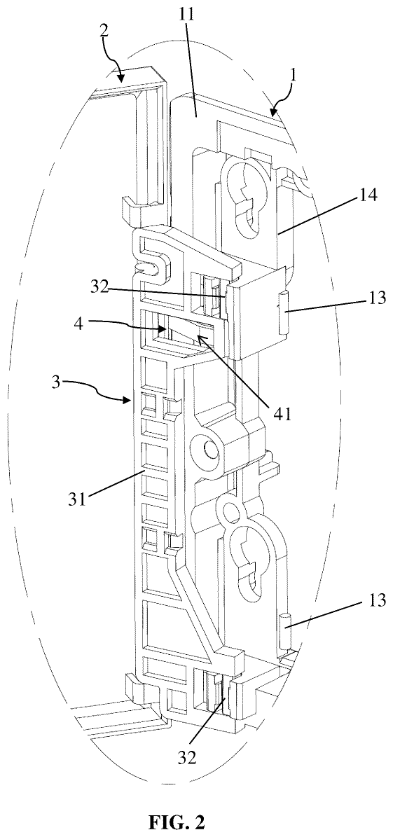

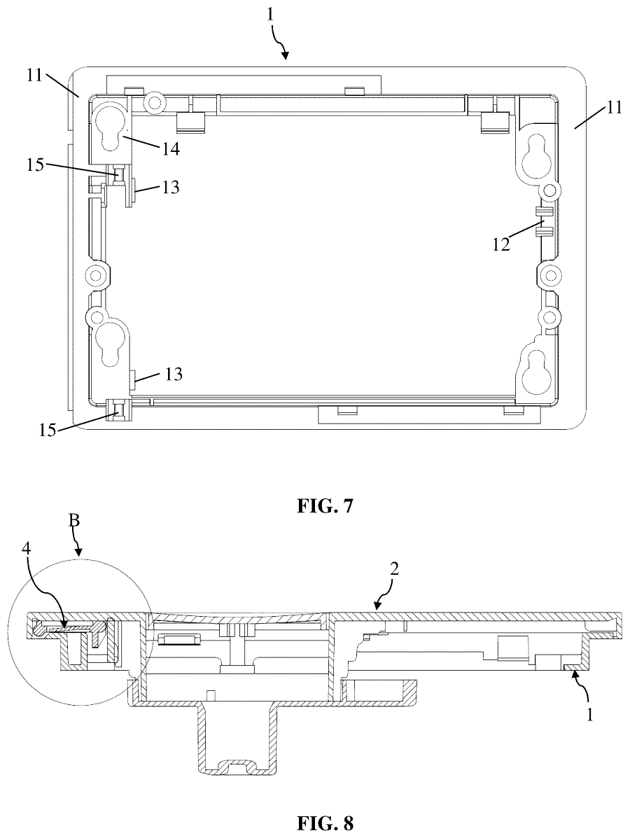

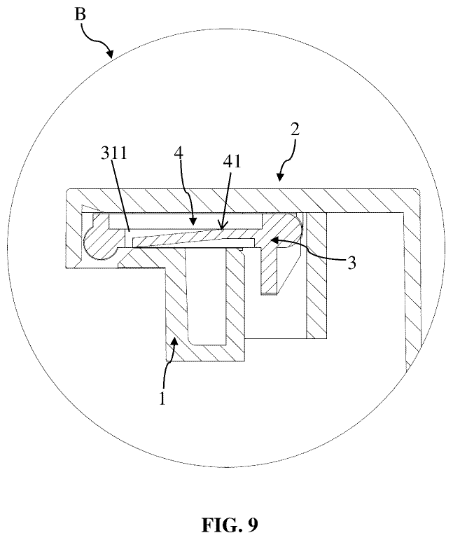

As shown in FIGS. 1-4 and 6-9, a panel assembly according to an embodiment of the present disclosure comprises a panel mounting frame 1, a panel cover 2, and a hinge 3 configured to connect the panel cover 2 to the panel mounting frame 1.

The hinge 3 comprises a hinge plate 31, a first pivot shaft 32, and a second pivot shaft 33, and the first pivot shaft 32 and the second pivot shaft 33 are disposed on opposite sides of the hinge plate 31.

The first pivot shaft 32 is pivotally connected to the panel mounting frame 1, and the second pivot shaft 33 is pivotally connected to the panel cover 2.

An elastic element 4 configured to drive the hinge plate 31 to rotate is disposed between the panel mounting frame 1 and the hinge plate 31.

The elastic element 4 is in a compressed state when the panel cover 2 is in a closed state relative to the panel mounting frame 1.

The pivotable connection according to the present disclosure means that two parts are connected by a pivot shaft, which allows two parts to rotate relative to each other.

The present disclosure provides a panel assembly for use in a hidden water tank. The panel assembly comprises the panel mounting frame 1, the panel cover 2, the hinge 3, and the elastic element 4.

The panel mounting frame 1 and the panel cover 2 are substantially in a rectangular shape, and the panel cover 2 includes buttons and other operating mechanisms configured to open a water valve in the water tank.

The hinge 3 comprises the hinge plate 31, the first pivot shaft 32, and the second pivot shaft 33, and the first pivot shaft 32 and the second pivot shaft 33 are connected to the opposite sides of the hinge plate 31.

The first pivot shaft 32 is pivotally connected to the panel mounting frame 1. Specifically, a first pivot portion 15 is disposed on an inner side of one frame edge 11 of the panel mounting assembly 1, and the first pivot shaft 32 is pivotally connected to the first pivot portion 15. The first pivot portion 15 may be a sleeve or a mounting plate having a through hole, and the first pivot shaft 32 is in clearance fit with (e.g., disposed in) the sleeve or the through hole of the mounting plate. If needed, an opening may be disposed in a side portion of the sleeve or the through hole so as to allow the first pivot shaft 32 to be assembled in the sleeve or the through hole.

The second pivot shaft 33 is pivotally connected to the panel cover 2. Specifically, a second pivot portion 23 is disposed on one side of the panel cover 2, and the second pivot shaft 33 is pivotally connected to the second pivot portion 23. The second pivot portion 23 may be a sleeve or a mounting plate having a through hole, and the second pivot shaft 33 is in clearance fit with (e.g., disposed in) the sleeve or the through hole of the mounting plate. If needed, an opening may be disposed in a side portion of the sleeve or the through hole so as to allow the second pivot shaft 33 to be assembled in the sleeve or the through hole.

The elastic element 4 may be a spring or an elastic sheet, and the elastic element 4 is assembled between the panel mounting frame 1 and the hinge plate 31 and configured to drive the hinge plate 31 to rotate to open at an angle. One mounting method of the elastic element 4 is that one end of the elastic element 4 is connected to the panel mounting frame 1, and the other end is connected to the hinge plate 31. Another mounting method of the elastic element 4 is that one end of the elastic element 4 is connected to the panel mounting frame 1, and the other end faces the hinge plate 31. Alternatively, one end of the elastic element 4 is connected to the hinge plate 31, and the other end faces the panel mounting frame 1.

When the user closes the panel cover 2, the elastic element 4 is compressed and thus in a compressed state.

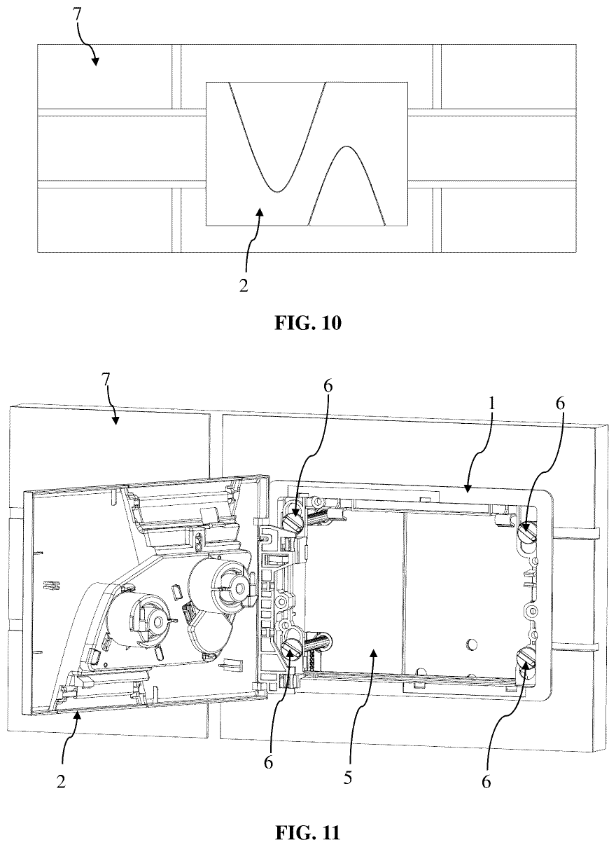

The present disclosure further provides a water tank assembly comprising a water tank 5, the panel assembly as described in the present disclosure, and at least one connecting member 6 configured to connect the panel assembly to the water tank 5. The mounting method of the panel assembly is shown in conjunction with FIGS. 10 and 11.

The water tank 5 is mounted in the wall 7, the wall 7 includes a wall opening, the panel mounting frame 1 is mounted at the wall opening, and the panel mounting frame 1 is connected to and fixed with the water tank 5 by means of connecting members 6.

As shown in FIG. 10, in the normal state, the panel cover 2 is snapped onto the panel mounting frame 1, and the elastic element 4 is in a compressed state.

As shown in FIG. 11, when the user opens the panel cover 2, one end of the panel cover 2 that is away from the hinge 3 is opened first, and then the elastic element 4 automatically drives the hinge plate 31 to rotate together, so that the panel cover 2 automatically opens to a certain angle and moves away from the wall. Then, the user only needs to turn over the panel cover 2 by hand to fully open the panel cover 2. This is convenient for operation and enhances the user experience.

In an embodiment, the toilet in the above embodiments may include a base (e.g., a pedestal, a bowl, etc.) and a tank (e.g., the tank 5). The base is configured to be attached to another object such as a drainpipe, floor, or another suitable object. The base includes a bowl, a sump (e.g., a receptacle) disposed below the bowl, and a trapway fluidly connecting the bowl to a drainpipe or sewage line. The tank may be supported by the base, such as an upper surface of a rim. The tank may be integrally formed with the base as a single unitary body. In other embodiments, the tank may be formed separately from the base and coupled (e.g., attached, secured, fastened, connected, etc.) to the base. The toilet may further include a tank lid covering an opening and inner cavity in the tank. The toilet may include a seat assembly including a seat and a seat cover rotatably coupled to the base. The toilet arrangement may further include a hinge assembly.

In another embodiment, the toilet arrangement includes a base and a seat assembly coupled to the base. The base includes a bowl, a sump disposed below the bowl, and a trapway fluidly connecting the bowl to a drainpipe or sewage line. The toilet arrangement includes a waterline that supplies the toilet with water. The toilet may further include a seat assembly including a seat and a seat cover rotatably coupled to the base. The toilets described above are provided herein as non-limiting examples of toilets that may be configured to utilize aspects of the present disclosure.

In some examples, a bidet may be included in a seat or pedestal of a toilet. In other examples, the bidet may be manufactured separately from and attached or coupled to a seat or pedestal of a toilet. The bidet includes a housing. The housing is configured to receive a flow of water through a housing inlet and dispense the flow of water from a housing outlet. The housing inlet and housing outlet may be located on opposite ends of the housing from one another, such that water may flow through the housing from the housing inlet to the housing outlet. In some examples, the housing further includes a chamber. As the housing receives the flow of water, the chamber may fill with water and provide a flow of water between the housing inlet and the housing outlet. The chamber may be configured to contain the flow of water and direct the flow of water from the housing inlet to the housing outlet. After the chamber has filled with water, the flow of water may travel along a substantially linear path between the housing inlet and the housing outlet. In some examples, one or more walls within the housing may be included to help direct a flow of water between the housing inlet and the housing outlet. The bidet may further include a housing inlet conduit configured to direct a flow of water to the housing inlet. The housing inlet conduit may be coupled to a water supply such as tank or waterline. The housing may further include a gear assembly or a portion of the gear assembly. The bidet may be a front wash bidet for female users and may use, generate, and/perform the functions related to nanobubbles, ozonated water, eWater, hydrogen peroxide generation, pH Control, template assisted crystallization, application of polyphosphates, filtration (ultrafiltration, nanofiltration, microfiltration, carbon/GAC), fluidic oscillating sprays, and adding other consumables in the water stream. For nanobubbles, air, ozone, oxygen, hydrogen, and carbon dioxide may be used.

In an embodiment, as shown in FIGS. 1-4, a frame edge extending plate 14 is disposed on an inner side of one frame edge 11 of the panel mounting frame 1, and the first pivot shaft 32 is pivotally connected to the frame edge extending plate 14.

The elastic element 4 is assembled between the hinge plate 31 and the frame edge extending plate 14.

In this embodiment, on the inner side of the frame edge 11 where the hinge 3 is mounted, the frame edge extending plate 14 configured to mount the first pivot portion 15 is provided, and the first pivot shaft 32 is pivotably connected to the frame edge extending plate 14. There is a distance between the first pivot shaft 32 and the frame edge 11, and the panel cover 2 moves toward the end opposite to the hinge 3 while moving outside the wall 7, when the panel cover 2 is opened by the action of the elastic member 4, so as to avoid the panel cover 2 from contacting the wall 7.

The frame edge extending plate 14 is also configured to assemble the elastic element 4 and compress the elastic element 4. This provides a larger mounting area and facilitates the mounting of the elastic element 4.

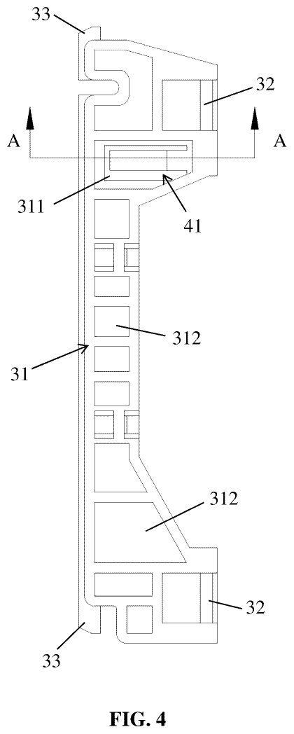

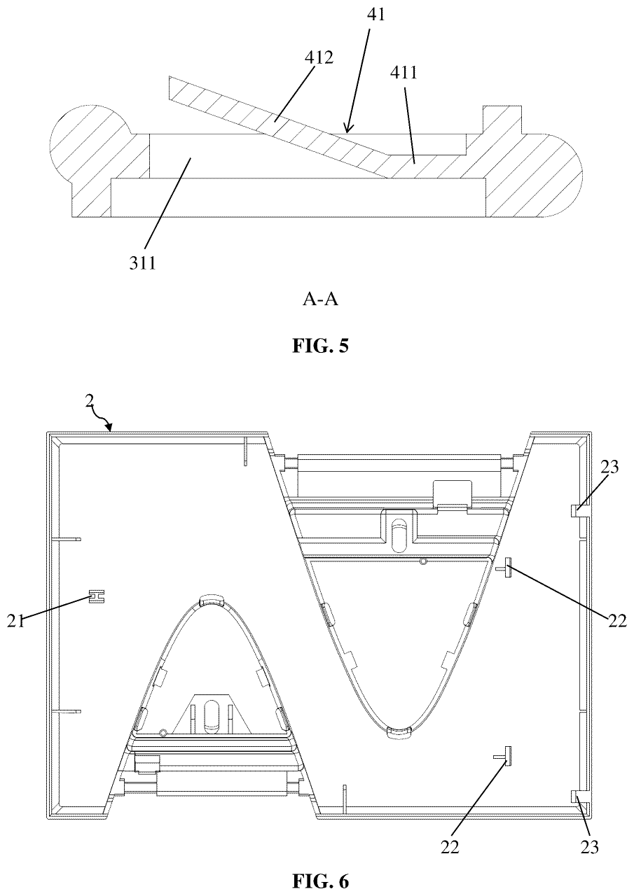

In an embodiment, as shown in FIGS. 1-5, the elastic element 4 comprises an elastic sheet 41, one end of the elastic sheet 41 is connected to the hinge plate 31 or the frame edge extending plate 14, and the other end of the elastic sheet 41 extends toward the frame edge extending plate 14 or the hinge plate 31.

In this embodiment, the elastic sheet 41 is used as the elastic element 4 and provides two connection methods as follows.

The first connection method is that one end of the elastic sheet 41 is connected to the hinge plate 31, the other end extends toward the frame edge extending plate 14, and when the panel cover 2 is closed, the other end of the elastic sheet 41 is pressed down by the frame edge extending plate 14 so as to be in a compressed state.

The second connection method is that one end of the elastic sheet 41 is connected to the frame edge extending plate 14, the other end extends towards the hinge plate 31, and when the panel cover 2 is closed, the other end of the elastic sheet 41 is pressed by the hinge plate 31 so as to be in a compressed state.

In an embodiment, as shown in FIGS. 1-5, the hinge plate 31 includes a hinge plate through hole 311, one end of the elastic sheet 41 is connected to the hinge 3, at least a portion of the elastic sheet 41 is located in the hinge plate through hole 311, and the other end of the elastic sheet 41 extends out of the hinge plate through hole 311 and extends toward the frame edge extending plate 14.

In this embodiment, a hinge plate 31 includes the hinge plate through hole 311 at a position where the elastic sheet 41 is mounted, and the hinge plate through hole 311 may be a rectangular hole having a length direction extending along a horizontal direction.

One end of the elastic sheet 41 is connected to the hinge 3, a portion of the elastic sheet 41 is disposed in the hinge plate through hole 311, the other end of the elastic sheet 41 extends out of the hinge plate through hole 311, and the other end of the elastic sheet 41 extends toward the frame edge extending plate 14.

When the other end of the elastic sheet 41 is pressed by the frame edge extending plate 14, the elastic sheet 41 may move toward the hinge plate through hole 311. This increases the amount of deformation of the elastic sheet 41 and promotes the elastic deformation capacity of the elastic sheet 41 to accumulate a larger force, so as to open the panel cover 2 more smoothly in the first stage.

In an embodiment, as shown in FIGS. 59, the elastic sheet 41 comprises a connecting sheet 411 and an inclined extending sheet 412 connected to the connecting sheet 411 and extending at an angle (e.g., obliquely with respect to the connecting sheet).

The connecting sheet 411 is disposed in the hinge plate through hole 311 and connected to a hole wall of the hinge plate through hole 311, and the inclined extending sheet 412 extends toward the frame edge extending plate 14.

When the panel cover 2 is in the closed state relative to the panel mounting frame 1, the inclined extending sheet 412 is compressed into the hinge plate through hole 311 by the frame edge extending plate 14.

In this embodiment, the elastic sheet 41 is consisted of or comprises the connecting sheet 411 and the inclined extending sheet 412. The connecting sheet 411 is disposed in the hinge plate through hole 311, and one end of the connecting sheet 411 is connected to the hole wall of the hinge plate through hole 311. The inclined extending sheet 412 is connected to the other end of the connecting sheet 411, and the inclined extending sheet 412 extends obliquely out of the hinge plate through hole 311 and extends toward the frame edge extending plate 14.

When the panel cover 2 is closed, the frame edge extending plate 14 presses against the inclined extending sheet 412 and compresses the inclined extending sheet 412 into the hinge plate through hole 311, so that the inclined extending sheet 412 accumulates force.

After the user opens the end of the panel cover 2 that is away from the hinge 3, the inclined extending sheet 412 pushes against the frame edge extending plate 14 and starts resetting, so as to cause the hinge 3 to drive the panel cover 2 to open at a certain angle.

In an embodiment, the elastic sheet 41 is integrally formed with the hinge plate 31. This is convenient for processing and shaping and has high structural strength.

The hinge 3 may be a plastic hinge, the elastic sheet 41 may be a plastic elastic sheet, and the hinge 3 and the elastic sheet 41 may be integrally injection molded.

In an embodiment, as shown in FIGS. 1-4, 6, and 7, the hinge plate 31 extends along a height direction of the panel mounting frame 1.

Two first pivot shafts 32 are disposed on one side of the hinge plate 31, and the two first pivot shafts 32 are arranged vertically apart from each other and pivotably connected to the panel mounting frame 1, respectively.

Two second pivot shafts 33 are disposed on the other side of the hinge plate 31, and the two second pivot shafts 33 are arranged vertically apart from each other and pivotably connected to the panel cover 2, respectively.

In this embodiment, the hinge plate 31 extends along the height direction of the panel mounting frame 1, with first pivot shafts 32 and second pivot shafts 33 disposed on both sides of upper and lower end portions of the hinge plate 31 respectively. Correspondingly, first pivot portions 15 are disposed on the inner side of the upper and lower end portions of the frame 11 adjacent to the hinge 3 respectively, and second pivot portions 23 are disposed on the upper and lower end portions of the panel cover 2 adjacent to the hinge 3 respectively. When the two first pivot shafts 32 are assembled, the two first pivot shafts 32 are respectively pivotally connected to the two first pivot portions 15, and the two second pivot shafts 33 are respectively pivotally connected to the two second pivot portions 23. This is beneficial for increasing the stability of the connection between the hinge 3 and the panel mounting frame 1 and the panel cover 2, as well as the rotational stability of the hinge 3.

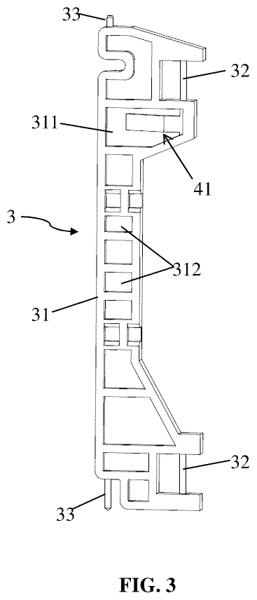

In an embodiment, as shown in FIGS. 3 and 4, the hinge plate 31 includes a plurality of lightening holes 312, which serves a weight reduction function and is beneficial for saving material.

In an embodiment, as shown in FIGS. 1, 6, and 7, on the side of the panel cover 2 away from the hinge 3, a first buckle 21 is provided, and on the side of the panel mounting frame 1 away from the hinge 3, an elastic clamping slot 12 is provided. When the panel cover 2 is in the closed state relative to the panel mounting frame 1, the first buckle 21 is fitted into the elastic clamping slot 12.

In this embodiment, the first buckle 21 is disposed at an end of the panel cover 2 away from the hinge 3, substantially located in the middle position of the panel cover 2 in the height direction. Correspondingly, the elastic clamping slot 12 is disposed on the side of the panel mounting frame 1 away from the hinge 3, on the inner side of one frame edge 11 away from the hinge 3. The slot walls on both sides of the elastic clamping slot 12 are adaptively deformable so that the first buckle 21 can be clamped into the elastic clamping slot 12 or separated from the elastic clamping slot 12.

When the user closes the panel cover 2, the first buckle 21 is clamped into the elastic clamping slot 12, and thus one end of the panel cover 2 away from the hinge 3 is secured. When the user needs to open the panel cover 2, the user can slightly pull the end of the panel cover 2 that is away from the hinge 3 outward, and thus the first buckle 21 is disengaged from the elastic clamping slot 12. Then, the hinge 3 is driven by the elastic element 4 to drive the panel cover 2 to open at a certain angle. In an embodiment, the user may press the end of the panel cover 2 away from the hinge 3 to make the first buckle 21 disengaged from the elastic clamping slot 12. When the user presses the end of the panel cover 2 away from the hinge 3, the elastic clamping slot 12 expands, and the elastic element 4 causes the first buckle 21 to be quickly disengaged from the elastic clamping slot 12 due to the acting force of the elastic element 4. Then, the hinge 3 is driven by the elastic element 4 to drive the panel cover 2 to open at a certain angle.

In an embodiment, as shown in FIGS. 1, 6, and 7, a second buckle 22 is disposed on the side of the panel cover 2 adjacent to the hinge 3, and a clamping convex 13 is disposed on an inner side of a frame edge of the panel mounting frame 1 adjacent to the hinge 3. When the panel cover 2 is in the closed state relative to the panel mounting frame 1, the second buckle 22 is clamped with the clamping convex 13.

In this embodiment, the second buckle 22 is disposed on the side of the panel cover 2 adjacent to the hinge 3, and correspondingly, the clamping convex 13 is disposed on the side of the panel mounting frame 1 adjacent to the hinge 3. The clamping convex 13 is substantially in a cylindrical or semi-cylindrical shape.

When the panel cover 2 is closed, the first buckle 21 is clamped into the elastic clamping slot 12, and the second buckle 22 is clamped with the clamping convex 13. This enables the panel cover 2 to be more securely fastened to the panel mounting frame 1. When the user opens the end of the panel cover 2 away from the hinge 3, the panel cover 2 only needs to be gently pulled outward, and the second buckle 22 may be uncoupled from the clamping convex 13, and then the elastic element 4 may cause the panel cover 2 to open to a certain angle first.

In the first stage, the panel cover 2 is opened to a certain angle by the action of the elastic element 4, the angle range is mainly determined by the elastic element 4, and the angle range can be selected between 10° and 30°.

In the second stage, the panel cover 2 is manually turned over by the user. After the panel cover 2 is fully opened, the angle between the panel cover 2 and the panel mounting frame 1 is about 120°, and the large opening angle facilitates the user in servicing (e.g., repairing) the water tank 5, mounting the panel mounting frame 1, and so on.

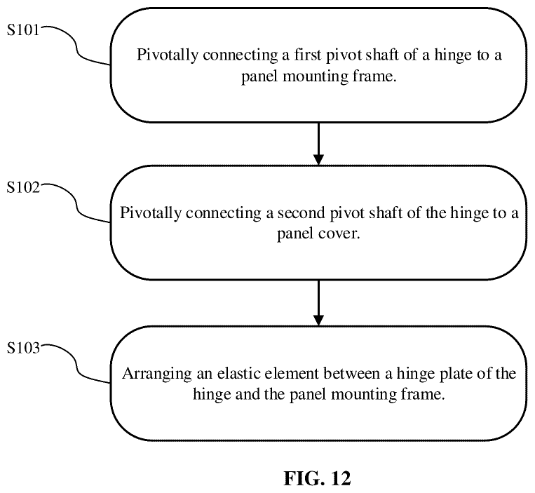

An embodiment of the present disclosure further provides a method for manufacturing a panel assembly. FIG. 12 is a flow chart of a method for manufacturing a panel assembly according to an embodiment of the present disclosure. Here, the panel assembly manufactured by the method is the panel assembly according to any of the embodiments of the present disclosure. The descriptions regarding the panel assembly as described in the present disclosure are incorporated herein. The panel assembly is configured to perform an operation, function, or the like as described in the present disclosure.

At act S101, the first pivot shaft 32 of the hinge 3 is pivotally connected to the panel mounting frame 1.

Specifically, as described above, the hinge 3 comprises a hinge plate 31, a first pivot shaft 32, and a second pivot shaft 33, and the first pivot shaft 32 and the second pivot shaft 33 are disposed on opposite sides of the hinge plate 31.

The first pivot shaft 32 is pivotally connected to the panel mounting frame 1. Specifically, a first pivot portion 15 is disposed on an inner side of one frame edge 11 of the panel mounting assembly 1, and the first pivot shaft 32 is pivotally connected to the first pivot portion 15. The first pivot portion 15 may be a sleeve or a mounting plate having a through hole, and the first pivot shaft 32 is in clearance fit with (e.g., disposed in) the sleeve or the through hole of the mounting plate. If needed, an opening may be disposed in a side portion of the sleeve or the through hole so as to allow the first pivot shaft 32 to be assembled in the sleeve or the through hole.

At act S102, the second pivot shaft 33 of the hinge 3 is pivotally connected to the panel cover 2.

Specifically, as described above, the second pivot shaft 33 is pivotally connected to the panel cover 2. Specifically, a second pivot portion 23 is disposed on one side of the panel cover 2, and the second pivot shaft 33 is pivotally connected to the second pivot portion 23. The second pivot portion 23 may be a sleeve or a mounting plate having a through hole, and the second pivot shaft 33 is in clearance fit with (e.g., disposed in) the sleeve or the through hole of the mounting plate. If needed, an opening may be disposed in a side portion of the sleeve or the through hole so as to allow the second pivot shaft 33 to be assembled in the sleeve or the through hole.

At act S103, the elastic element 4 is arranged between the hinge plate 31 of the hinge 3 and the panel mounting frame 1.

Specifically, as described above, as shown in FIGS. 1-5, the elastic element 4 comprises an elastic sheet 41, one end of the elastic sheet 41 is connected to the hinge plate 31 or the frame edge extending plate 14, and the other end of the elastic sheet 41 extends toward the frame edge extending plate 14 or the hinge plate 31.

In an embodiment, as shown in FIGS. 1-5, the hinge plate 31 includes a hinge plate through hole 311, one end of the elastic sheet 41 is connected to the hinge 3, at least a portion of the elastic sheet 41 is located in the hinge plate through hole 311, and the other end of the elastic sheet 41 extends out of the hinge plate through hole 311 and extends toward the frame edge extending plate 14.

When the other end of the elastic sheet 41 is pressed by the frame edge extending plate 14, the elastic sheet 41 may move toward the hinge plate through hole 311. This increases the amount of deformation of the elastic sheet 41 and promotes the elastic deformation capacity of the elastic sheet 41 to accumulate a larger force, so as to open the panel cover 2 more smoothly in the first stage.

The above technical solutions may be combined as required to achieve the technical effects.

The above descriptions are merely intended to illustrate the principle and the embodiments of the present disclosure. It should be pointed out that, for those having ordinary skill in the art, other variations may be made based on the principle of the present disclosure, which should also be regarded as falling in the protection scope of the present disclosure.

1-10. (canceled)

11. A panel assembly, comprising:
a panel mounting frame;
a panel cover;
a hinge configured to connect the panel cover to the panel mounting frame, the hinge comprising:
a hinge plate;
a first pivot shaft disposed on a first side of the hinge plate and configured to be pivotally connected to the panel mounting frame; and
a second pivot shaft disposed on a second side of the hinge plate and configured to be pivotally connected to the panel cover; and
an elastic element configured to drive the hinge plate to rotate and disposed between the panel mounting frame and the hinge plate,
wherein the elastic element is in a compressed state when the panel cover is in a closed state relative to the panel mounting frame.

12. The panel assembly according to claim 11, further comprising:
a frame edge extending plate disposed on an inner side of a frame edge of the panel mounting frame,
wherein the first pivot shaft is configured to be pivotally connected to the frame edge extending plate, and
wherein the elastic element is disposed between the hinge plate and the frame edge extending plate.

13. The panel assembly according to claim 12, wherein the elastic element comprises an elastic sheet including:
a first end configured to be connected to the hinge plate or the frame edge extending plate; and
a second end configured to extend toward the frame edge extending plate or the hinge plate.

14. The panel assembly according to claim 13, wherein the hinge plate comprises a hinge plate through hole,
wherein the first end of the elastic sheet configured to be connected to the hinge,
wherein at least a portion of the elastic sheet is configured to be disposed in the hinge plate through hole, and
wherein the second end of the elastic sheet is configured to extend out of the hinge plate through hole and extend toward the frame edge extending plate.

15. The panel assembly according to claim 14, wherein the elastic sheet comprises a connecting sheet and an inclined extending sheet connected to the connecting sheet and extending at an angle with respect to the connecting sheet,
wherein the connecting sheet is configured to be disposed in the hinge plate through hole and connected to a hole wall of the hinge plate through hole,
wherein the inclined extending sheet configured to extend toward the frame edge extending plate,
wherein, when the panel cover is in the closed state relative to the panel mounting frame, the inclined extending sheet is compressed into the hinge plate through hole by the frame edge extending plate.

16. The panel assembly according to claim 14, wherein the elastic sheet is integrally formed with the hinge plate.

17. The panel assembly according to claim 11, wherein the hinge plate extends along a height direction of the panel mounting frame,
wherein the hinge comprises two first pivot shafts disposed on the first side of the hinge plate,
wherein the two first pivot shafts are arranged vertically apart from each other and configured to be pivotably connected to the panel mounting frame, respectively,
wherein the hinge comprises two second pivot shafts disposed on the second side of the hinge plate, and
wherein the two second pivot shafts are arranged vertically apart from each other and configured to be pivotably connected to the panel cover, respectively.

18. The panel assembly according to claim 11, wherein the hinge plate comprises a plurality of lightening holes.

19. The panel assembly according to claim 11, further comprising:
a first buckle disposed on a first side, away from the hinge, of the panel cover,
an elastic clamping slot disposed on a second side, away from the hinge, of the panel mounting frame,
wherein, when the panel cover is in the closed state relative to the panel mounting frame, the first buckle is engaged with the elastic clamping slot.

20. The panel assembly according to claim 19, further comprising:
a second buckle disposed on a second side, adjacent to the hinge, of the panel; and
a clamping convex disposed on a second side, adjacent to the hinge, of the panel mounting frame,
wherein when the panel cover is in the closed state relative to the panel mounting frame, the second buckle is engaged with the clamping convex.

21. A water tank assembly, comprising:
a water tank configured to be installed in a wall;
a panel assembly comprising:
a panel mounting frame;
a panel cover;
a hinge configured to connect the panel cover to the panel mounting frame, the hinge comprising:
a hinge plate;
a first pivot shaft disposed on a first side of the hinge plate and configured to be pivotally connected to the panel mounting frame; and
a second pivot shaft disposed on a second side of the hinge plate and configured to be pivotally connected to the panel cover; and
an elastic element configured to drive the hinge plate to rotate and disposed between the panel mounting frame and the hinge plate; and
a connecting member configured to connect the panel assembly to the water tank,
wherein the elastic element is in a compressed state when the panel cover is in a closed state relative to the panel mounting frame.

22. The water tank assembly according to claim 21, further comprising:
a frame edge extending plate disposed on an inner side of a frame edge of the panel mounting frame,
wherein the first pivot shaft is configured to be pivotally connected to the frame edge extending plate, and
wherein the elastic element is disposed between the hinge plate and the frame edge extending plate.

23. The water tank assembly according to claim 22, wherein the elastic element comprises an elastic sheet including:
a first end configured to be connected to the hinge plate or the frame edge extending plate; and
a second end configured to extend toward the frame edge extending plate or the hinge plate.

24. The water tank assembly according to claim 23, wherein the hinge plate comprises a hinge plate through hole,
wherein the first end of the elastic sheet configured to be connected to the hinge,
wherein at least a portion of the elastic sheet is configured to be disposed in the hinge plate through hole, and
wherein the second end of the elastic sheet is configured to extend out of the hinge plate through hole and extend toward the frame edge extending plate.

25. The water tank assembly according to claim 24, wherein the elastic sheet comprises a connecting sheet and an inclined extending sheet connected to the connecting sheet and extending at an angle with respect to the connecting sheet,
wherein the connecting sheet is configured to be disposed in the hinge plate through hole and connected to a hole wall of the hinge plate through hole,
wherein the inclined extending sheet configured to extend toward the frame edge extending plate,
wherein, when the panel cover is in the closed state relative to the panel mounting frame, the inclined extending sheet is compressed into the hinge plate through hole by the frame edge extending plate.

26. The water tank assembly according to claim 24, wherein the elastic sheet is integrally formed with the hinge plate.

27. The water tank assembly according to claim 21, wherein the hinge plate extends along a height direction of the panel mounting frame,
wherein the hinge comprises two first pivot shafts disposed on the first side of the hinge plate,
wherein the two first pivot shafts are arranged vertically apart from each other and configured to be pivotably connected to the panel mounting frame, respectively,
wherein the hinge comprises two second pivot shafts disposed on the second side of the hinge plate, and
wherein the two second pivot shafts are arranged vertically apart from each other and configured to be pivotably connected to the panel cover, respectively.

28. The water tank assembly according to claim 21, wherein the hinge plate comprises a plurality of lightening holes.

29. A method for manufacturing a panel assembly, the method comprising:
pivotally connecting a first pivot shaft of a hinge to a panel mounting frame;
pivotally connecting a second pivot shaft of the hinge to a panel cover; and
arranging an elastic element between a hinge plate of the hinge and the panel mounting frame.

30. The method according to claim 29, wherein the elastic element comprises an elastic sheet,
wherein arranging the elastic element between the hinge plate of the hinge and the panel mounting frame comprises:
connecting a first end of the elastic sheet to the hinge plate;
disposing at least a portion of the elastic sheet in a hinge plate through hole of the hinge plate; and
extending a second end of the elastic sheet out of the hinge plate through hole and toward a frame edge extending plate disposed on an inner side of a frame edge of the panel mounting frame.
